(19) United States
(12) Patent Application Publication
(10) Pub. No.: US 2003/0204976 A1
(43) Pub. Date: Nov. 6, 2003

(54) Lighting fixture

(76) Inventors: Lee A. Doerr JR., Mequon, WI (US); Janice M. Doerr, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 10/136,127

(22) Filed: May 1, 2002

(51) Int. Cl. G09F 13/00

(52) U.S. Cl. 40/553

(57) ABSTRACT

A lighting fixture is disclosed which projects light along the wall on which it is mounted. The fixture also illuminates a frontal, multi-colored informational and/or decorative display. The frontal display consists of a variety of sandwiched light transmitting colored elements such as marbles that permit creation of customized and adjustable illuminated signage/decoration.

### CROSS-REFERENCE TO RELATED APPLICATIONS

Not applicable.

### STATEMENT OF FEDERALLY SPONSORED RESEARCH OR DEVELOPMENT

Not applicable.

### BACKGROUND OF THE INVENTION

This invention relates to wall mountable lighting fixtures, and in particular to light fixtures having an ornamental or informational colored display.

It is conventional to provide a box-type metallic casing that has an open forward side. An electrical light and associated electrical controls are positioned in the casing and a transparent or translucent panel is then positioned over the front of the light casing. The panel will typically have printed thereon (in one or more colors) informational messages (e.g. “EXIT”), or have an ornamental design (e.g. an advertising picture of a hamburger at a fast food restaurant). To change the message/display a completely new panel is required.

It is also conventional to provide stained glass windows and Tiffany® lampshades in which segments of different colors of essentially flat pieces of glass are fixed in position in a pane or other sheet-like structure. The colored sheets often depict religious or other scenes, albeit in some cases abstract art or text messages are depicted.

These sheets are typically illuminated from the rear by natural light (e.g. sunlight through a stained glass window) or lamp light (e.g. projecting through a lampshade). Once these designs have been created at the factory or other production location it is very difficult to change them without replacing the whole sheet.

There have thus been some attempts to provide changeable signs made of separate and movable color elements. These range from designs created out of exposed colored Christmas tree lights to more compact displays in which the colored elements are closely grouped in a defined supporting structure. See U.S. Pat. No. 1,755,315. However, these designs typically provide the color element in a position where it is susceptible to vandalism. This limits the uses to which such fixtures and lighting can be made.

There have also been some attempts to backlight a display panel with a rearward array of segmented color prism elements. However, the individual segments are not visible during use, and light passing through them is mixed.

In unrelated activities not involving signage messages it is also known to provide wall mountable light units that project outward from the wall somewhat. Some such units have top and bottom openings in their housing so as to project light up and down along the wall. Examples of such lights are provided by SPI Lighting, Inc.

Notwithstanding the varied lighting fixtures that exist in the prior art, a need still exists for the creation of improved lighting fixtures which both serve the basic lighting function and also have a colored informational or artwork display that can easily be customized or changed.

### SUMMARY OF THE INVENTION

The invention provides a lighting fixture that has a casing in which is positioned an electrical light (e.g. fluorescent; incandescent; other). There is a display mountable to a front of the casing, the display having a front panel and a rear panel and a plurality of colored segments that can transmit light there through sandwiched and retained by and between the front panel and rear panel so that the colored segments are visible through the front panel when the light fixture is operational.

The front panel and the rear panel each have alignable regions which cooperate to retain the color segments and permit light from the light to pass through the rear panel, through the colored segments, and through the front panel. At least one of the colored segments is a first color, and other of said colored segments are not that color. The colored segments are preferably clamped at defined positions between the front panel and rear panel. In one form the rear panel is not integral with the casing. In another it is an integral part of the casing.

The alignable regions are preferably similarly shaped holes which cooperate to retain the color segments at the defined positions (e.g. circular holes of similar size). For the purposes of this patent the term “color” is deemed to also include any color, including without limitation essentially clear colors such as untinted glass color.

In other preferred forms the colored segments are spherical (e.g. like a marble having a diameter of an inch or less), or otherwise have a forward portion that narrows forwardly and a rearward portion that narrows rearwardly. To even out the intensity of the light it is preferred that there be a translucent light diffusing plate positioned in front of the lighting source and rearward of the rear panel of the display. Absent such a diffuser, those marbles radially closest to the light unit might appear brighter.

It will be appreciated that when the lighting source emits a light, an informational message can be illuminated through the front panel of the display if one selects the colors of the marbles with this goal in mind. For example, all segments other than the message could be a clear glass color, with those segments that spell out the word “UP” (or another message) being in red or another vibrant color. Alternatively, the segments could depict a decorative design such as a corporate logo, a religious symbol, or the like.

Apart from light transmitted through the colored members, it is also preferred to provide radial openings along the rear casing. This permits light to be radially projected from the fixture such that the light will bounce off the wall on which the fixture is mounted.

The parts of the light fixture can be inexpensively produced and assembled. Further, the frontal display can be set up at a factory location using either hand labor or automated equipment to create a customer selected design. Also, with appropriate removal of bolting, the display can be modified by the customer by their taking the front panel off when the unit is horizontal, revising the position of the marbles, and reclamping the front panel to the rear panel. This might be desired if a company were to want to change its name, or if a particular direction or message was no longer appropriate.

Apart from the benefits that the light fixture has a message or decorative sign, the light fixture can also project significant amounts of light up and down along a wall where the fixture is mounted. As the source of light can be fluorescent, incandescent, or any other convenient source of electrical light, a variety of lighting effects and lighting colors can be projected in this manner.

These and still other advantages of the invention will be apparent from the detailed description and drawings which follow.

### BRIEF DESCRIPTION OF THE DRAWINGS

FIG. 1 is a perspective view of a lighting fixture of the present invention that is mounted on a wall;

FIG. 2 is a front plan view thereof where the display illuminates a red circle with a red slash (an international symbol for prohibited access);

FIG. 3 is a sectional view taken along line 3-3 of FIG. 2;

FIG. 4 is an exploded perspective view of the FIG. 1 lighting fixture;

FIG. 5 is a front view of a second embodiment that is similar to the first except that the front panel is essentially rectangular, and the word “UP” is spelled out by the display;

FIG. 6 is a detailed sectional view taken along line 6-6 of FIG. 5;

FIG. 7 is a view similar to FIG. 5, but of a third embodiment in which the holes and segmented pieces are more square; and

FIG. 8 is a view similar to FIG. 6, but taken along 8-8 of FIG. 7.

### DETAILED DESCRIPTION OF THE PREFERRED EMBODIMENTS

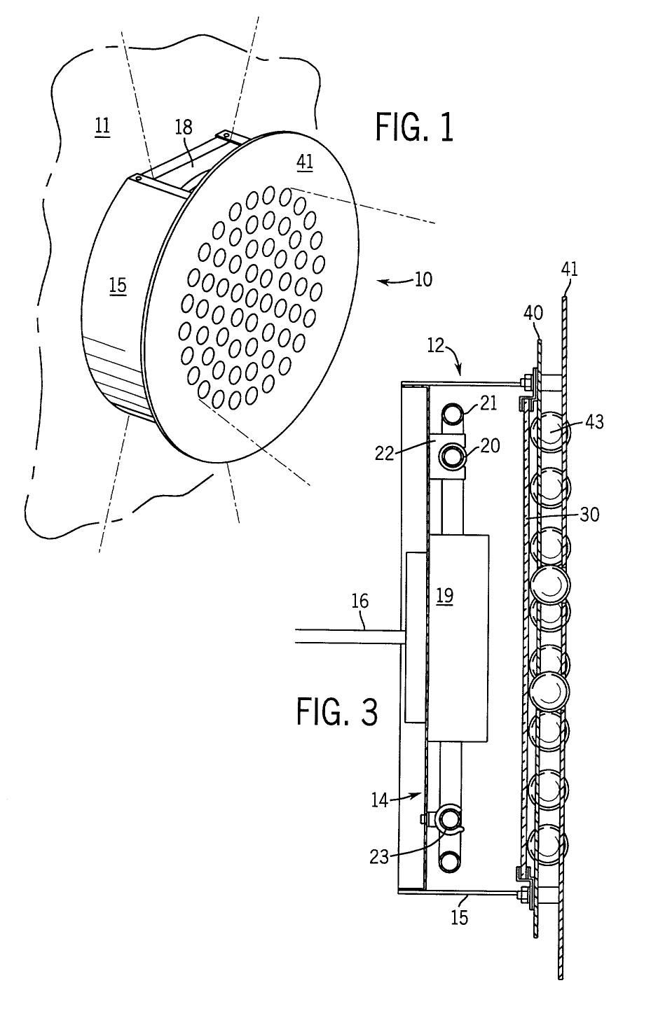

The invention provides a lighting fixture generally referred to with numeral 10. It is mountable on a vertical or other wall 11 to project light along the wall, as well as outward through its front. For purposes of this application, the term “front” will refer to the display direction, regardless of the orientation of the device relative to the wall. Thus, if the device were mounted on a ceiling the front would be the bottom. If the device were mounted on a vertical wall (as shown in FIG. 1), the front would be the direction away from the wall.

The unit 10 has a rearward casing 12 that has a rear panel 14 bolted to a generally cylindrical side wall 15. Electrical power is supplied by the usual cord 16 (see FIG. 3) that supplies power to a ballast and associated electrical controls 19 that are mounted on and through the rear plate 14. The ballast feeds power to two concentric fluorescent bulbs 20/21 which are mounted in clips 22/23.

The side wall 15 may be integrally connected to a rear display wall 40. Alternatively, the rear display wall 40 may be separately formed and bolted to the side wall 15.

A diffuser plate 30 can be mounted immediately behind the wall 40, such as by a bracket and bolting. The diffuser plate may be (if desired) a translucent glass so that when light from the fluorescent bulbs is transmitted through it the forwardly directed light will be relatively uniform (not two rings of bright light).

A front display panel 41 is also provided. It, and the rear display panel 40, are shown as having similar and alignable arrays of holes. While the panels 40/41 are preferably metal, other materials can be used which do not transmit light in a significant manner (except through the holes).

When the assembled lighting fixture (apart from the front panel 41 and marbles 43) is placed on a horizontal table with panel 14 downward, a plurality of translucent or transparent (or mixtures thereof) segmented differently colored 3-dimensional marbles 43 can be selectively positioned on the hole array of the rear panel 40. This can be done manually, albeit software and machines can be developed to provide this assembly in a more automated manner.

In a preferred form the marbles are spherical, transparent, colored glass marbles 43, some of which are of one color and at least one of which is of another color. Alternatively, the segments could be made of plastic or other material that transmits light and is heat resistant.

The shapes of the segments need not be spherical. A variety of other shapes can be used, albeit where a more square configuration is used a corresponding change, as shown in FIGS. 7 and 8, may be needed to the hole configuration. In any event, it is highly preferred that the segments taper or otherwise narrow to the front or to the rear to facilitate their being held in place.

It should be recognized if these regions of wall 40 or 41 were transparent (and not an array of holes), one might not need an array of holes in one of the panels (e.g. the rear panel could have the holes and the front panel could be entirely transparent).

Also, if appropriate seats are provided on at least one panel where the array of holes were, no such holes may be needed on either panel. The important feature is that some means be provided (e.g. holes; seats; adhesive) to fix the colored members in a specified array for the duration desired by the consumer, preferably while leaving the option to adjust the positioning.

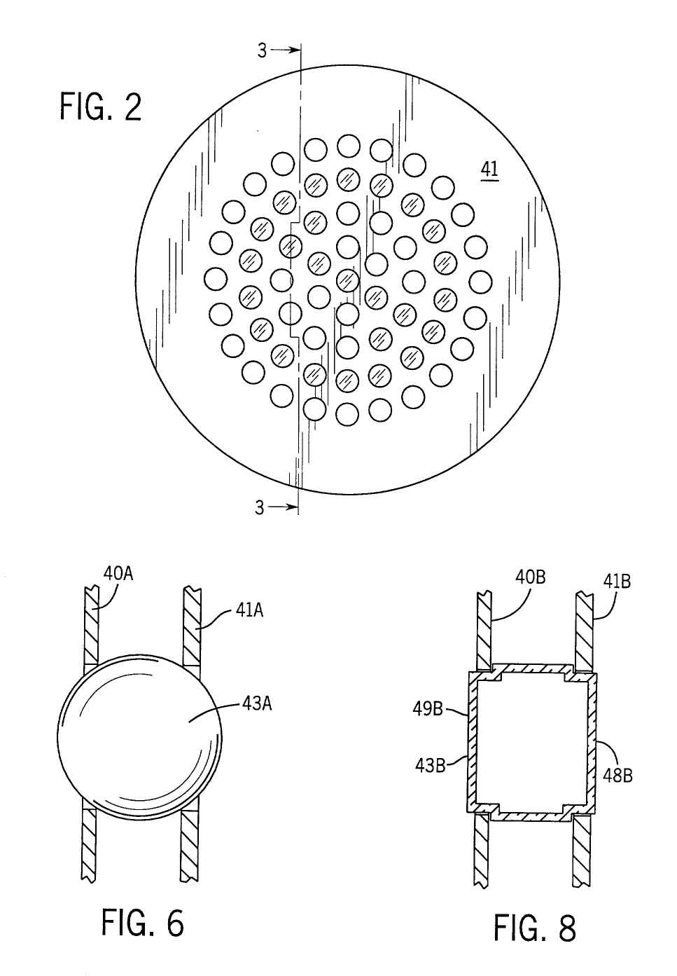

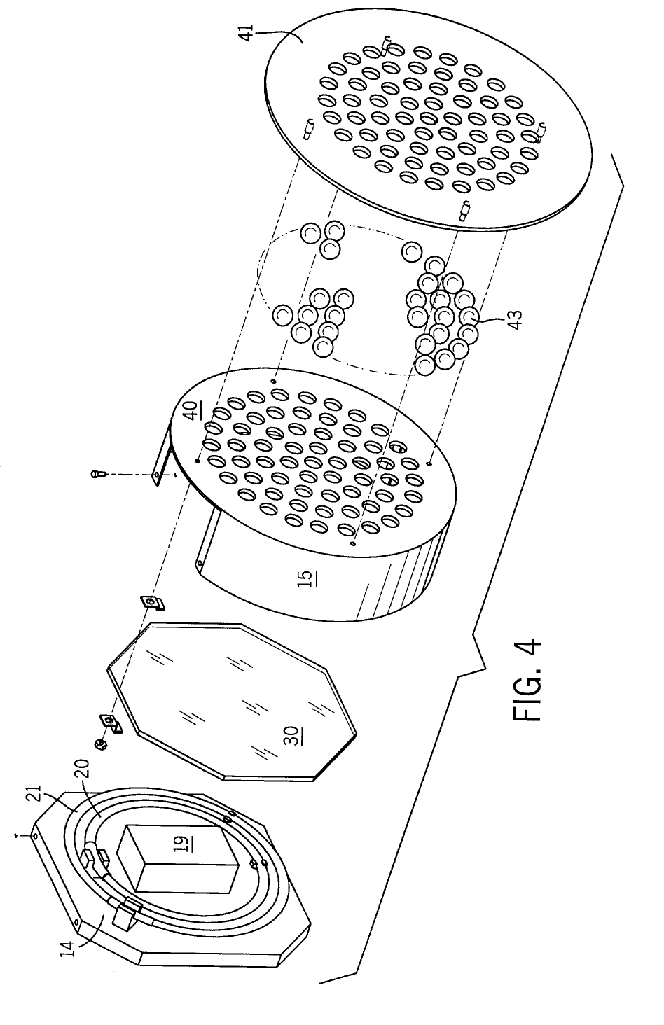

It should be understood that such displays can depict a symbolic message (e.g. the red international circle and slash in FIG. 2), or a word message (e.g. the word “UP” in FIGS. 4 and 6), or a representational or abstract piece of artwork (e.g. a corporate logo) when the light fixture is lit. Such messages and/or designs might also be visible to some extent when the light is not lit, albeit this is not required.

When spherical shapes are used for element 43, they can be loosely clamped so as to permit some rotation of the element in the “socket” formed between the panels 40 and 41. Thus, if the front of the marble becomes chipped through misuse or vandalism, the marble can then be rotated so that the damaged portion is not visible (without having to remove the front panel 41).

Should a customer wish to change the message/decoration (e.g. “UP” to “DOWN”), this can be achieved by positioning the unit with the panel 14 downward, unbolting the front panel 41 from the casing, and then repositioning the marbles 43 to the desired configuration (and/or introducing other colors or quantities of a particular color of marbles). It is often preferred to use clear or light color(s) for background, while using dark and more vibrant colors (e.g. red) to depict informational content.

Note that FIG. 1 shows side wall 15 having upper and lower openings 18 to permit light to project along and against the wall that the unit is mounted on. This reduces glare which might be caused by leaving a direct unshaded opening in a forward direction.

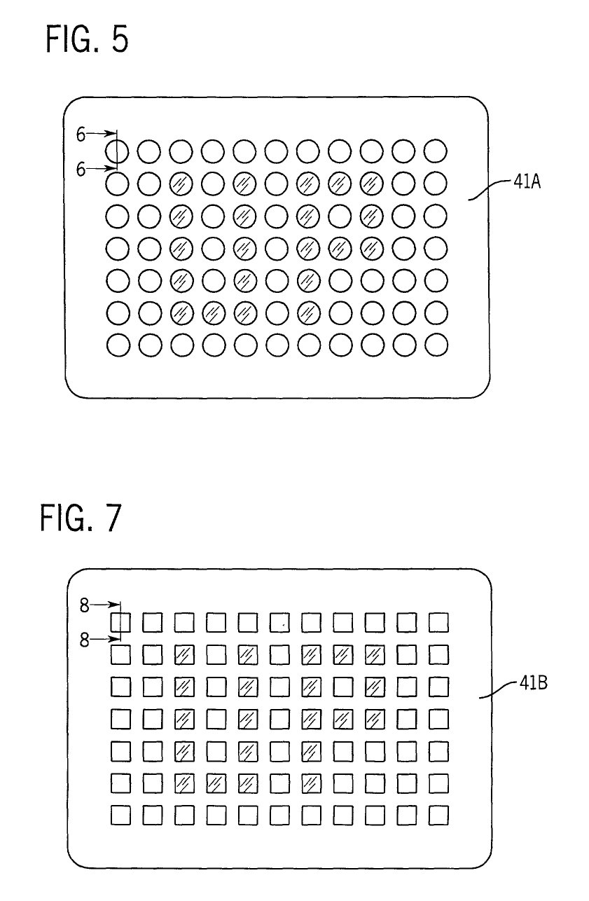

FIG. 5 shows that the front plate 41A can have other shapes, such as a contoured rectangular shape. In such a case the corresponding side wall 15A (not shown) could be circular, but preferably is more rectangular with upper and lower openings 18A (not shown).

As shown in FIG. 6, the panel 41B could have square holes instead. In such a case the glass block 43B could be more square but with narrowed frontal and rear areas 48B and 49B to facilitate positioning of the element prior to clamping between the rear 40B and front 41B plates.

While the above discloses preferred embodiments of the invention, it should be appreciated that the invention can be applied in still other forms. For example, the holes in the front and rear panel can be made much smaller, as can the marbles, such that a much more complex design can be depicted in a given space.

Also, it is not required that the fixture project out from the wall. In such a case the holes 18 could be eliminated. Moreover, the fixture can be mounted to other structures, such as a ceiling, billboard or piece of furniture. These, and many other, modifications may be made to the preferred embodiments without departing from the scope and spirit of the claims. Thus, the claims should be looked to in order to judge the full scope of the invention.

### Industrial Applicability

The invention provides an lighting fixture capable of displaying informational and/or decorative content.

We claim:

1. A lighting fixture, comprising:
a casing in which is positioned an electrical light;
a display mountable to a front of the casing, the display having a front panel and a rear panel and a plurality of colored segments that can transmit light there through sandwiched and retained by and between the front panel and rear panel so that the colored segments are visible through the front panel when the light fixture is operational, the front panel and the rear panel each having alignable regions which cooperate to retain the color segments and permit light from the light to pass through the rear panel, through the colored segments, and through the front panel;
wherein at least one of the colored segments is a first color, and other of said colored segments are not that color.

2. The lighting fixture of claim 1, wherein the alignable regions are an array of holes in the rear panel and an array of holes in the front panel.

3. The lighting fixture of claim 1, wherein the colored segments are spherical.

4. The lighting fixture of claim 1, wherein the colored segments have a forward portion that narrows forwardly and a rearward portion that narrows rearwardly.

5. The lighting fixture of claim 1, further comprising a translucent light diffusing plate positioned in front of the light and rearward of the rear panel of the display.

6. The lighting fixture of claim 1, wherein when the light emits a light an informational message is depicted through the front panel of the display.

7. The lighting fixture of claim 6, wherein the information message comprises at least two letters.

8. The lighting fixture of claim 1, wherein when the light emits a light a decorative design is depicted through the front panel of the display.

9. The lighting fixture of claim 1, wherein the casing has a lateral opening for permitting light to be radially projected from the fixture.
